(19) United States
(12) Patent Application Publication
(10) Pub. No.: US 2008/0270802 A1
(43) Pub. Date: Oct. 30, 2008

(54) METHOD AND SYSTEM FOR PROTECTING PERSONALLY IDENTIFIABLE INFORMATION

(76) Inventors: Paul Anthony Ashley, Brisbane (AU); Sridhar R. Muppidi, Austin, TX (US); Mark Vandenwauver, Suffolk, VA (US)

Correspondence Address: IBM CORP. (DHJ);c/o DAVID H. JUDSON, 15950 DALLAS PARKWAY, SUITE 225, DALLAS, TX, 75248, US

(21) Appl. No.: 11/739,207

(22) Filed: Apr. 24, 2007

(51) Int. Cl. H04K 1/00

(52) U.S. Cl. 713/184

(57) ABSTRACT

The present invention provides a way to protect PII (or, more generally, any user “sensitive” information) throughout its life cycle in an organization. The techniques described herein ensure that a user's PII is protecting during storage, access or transfer of the data. Preferably, this objective is accomplished by associating given metadata with a given piece of PII and then storing the PII and metadata in a “privacy protecting envelope.” The given metadata includes, without limitation, the privacy policy that applies to the PII, as well as a set of one more purpose usages for the PII that the system has collected from an end user's user agent (e.g., a web browser), preferably in an automated manner. Preferably, the PII data, the privacy policy, and the user preferences (the purpose usages) are formatted in a structured document, such as XML. The information in the XML document (as well as the document itself) is then protected against misuse during storage, access or transfer using one or more of the following techniques: encryption, digital signatures, and digital rights management.

### RELATED APPLICATION

This application is related to commonly-owned U.S. Ser. No. 11/______, filed ______, 2007, titled “Method and system for automating privacy usage selection on web sites.”

### BACKGROUND OF THE INVENTION

1. Technical Field

The present invention relates generally to automating information exchange within an online web-based environment.

2. Background of the Related Art

In the content of information security and privacy, so-called “personally identifiable information” or “personally identifying information” (PII) is any piece of information that can be used to uniquely identify, contact or locate a given person. In today's online world, an end user frequently visits numerous web sites on a daily basis to obtain information, transact electronic commerce, and perform other work- or entertainment-related functions. Virtually every visit to every web site presents an opportunity for an organization to obtain an end user's PII.

Before an online user provides personally identifiable information to an organization, the user should be fully aware of the organization's privacy policy, and he or she should be given a choice of different “purpose usages” for such information. In particular, the user should be given an opportunity (e.g., via web-based HTML fill-in forms or the like) to indicate to the organization which of the purpose usages for the PII he or she is willing to permit. For example, the user may decide that the organization can use his or her PII for one or more different scenarios, e.g.: for a given transaction only, for shipping goods to the user, for billing the user, for sending e-mail marketing information, for providing the PII to a third party. Each of the examples is a “purpose usage” for the PII, and they are merely exemplary. In the past, it has been known in the art to provide a user visiting a web site with a web-based form from which the user can select one or more purpose usages. In particular, when the user provides PII to an organization, the user may be queried with a list of purpose usages, or with a specific purpose usage. An example of this known approach is shown in FIG. 1, which is a screen shot of a web browser that includes an HTML form with several such requests. In the illustrated example, the end user is submitting given PII (residence address, email address, credit card data, or the like) and is being asked whether such PII can be re-used from some other purpose. The purpose usages are shown circled in the figure. The end user then is forced to manually input a response, often on a purpose usage-by-purpose usage basis. For most web users, the process is slow and tiresome and, thus, it inhibits efficient online business and information exchange.

It is also known in the art to automate the process of notifying an end user about a privacy policy enforced on the web site to which the end user has navigated. The Platform for Privacy Preferences (P3P) is a Web standard that provides this functionality. In particular, an enabled user agent (e.g., a web browser that conforms to the P3P standard) reads P3P files (typically in the form of Extensible Markup Language, or XML) from the web site automatically and then indicates to the user if the site's P3P policy matches the user agent privacy settings. In effect, a P3P-enabled web browser acts as an alerting mechanism to inform the end user if the end user's privacy settings can be accommodated on the web site. In this way, P3P automates the process of comparing the user's own privacy preferences with the privacy policy of a web site.

Although P3P does reduce the time necessary for the user to understand an organization's privacy policy, it does not address purpose usage or provide any mechanism for enabling an end user to indicate to the organization his or her purpose usage selections. Accordingly, even if a site is P3P-compliant, the selection of purpose usages still is a manual process.

Another problem that often impairs good privacy management is that organizations do not have effective means for protecting PII from misuse once it is received. An individual's PII should only be used in accordance with an organization's privacy policy, and then only for the identified purpose usage. Current solutions for providing protection fall short. In particular, the solutions tend to focus on trying to solve one aspect of the data protection problem without looking at all ways that PII data can be compromised. Thus, for example, database systems claim that database security provides adequate protection of PII data. Although this is true, the assertion does not address what happens to the data as it is being submitted to the database, or after the data is transmitted from the database. It also does not address the fact that database administrators have access to the PII, which can compromise the data in certain circumstances. Other solutions, such as those based on access control, do not address the storage or transfer of PII data. These access control solution also do not take into account that each piece of PII may need to be treated differently under an organization's privacy policy (or a user purpose usage preference) that is in place at the time the PII is received in the organization. Typically, access control systems treat all PII under a single policy or set of user preferences. Finally, the need to protect sensitive data during transfer of that data within the organization (or to and from the organization) is often neglected. The entity receiving the PII must know how to treat the data (as indicated by the associated privacy policy and user preferences), but that entity must also ensure that the information is protected against wrongful disclosure or misuse during transfer.

### BRIEF SUMMARY OF THE INVENTION

According to the present invention, a method implemented as a Web service is used to generate a secure information envelope for personally identifying information (PII). The method begins in response to a query from a user agent that has been pre-configured with a set of one or more purpose usage selections. In response, the user agent is provided a purpose usage option. After receiving from the user agent at least one purpose usage setting from the set of one or more purpose usage selections that have been pre-configured, given PII is then received. According to the method, a given function is then applied to the PII, the at least one purpose usage setting and the privacy policy to generate the secure information envelope.

The present invention provides a way to protect PII (or, more generally, any user “sensitive” information) throughout its life cycle in an organization. The techniques described herein ensure that a user's PII is protecting during storage, access or transfer of the data. Preferably, this objective is accomplished by associating given metadata with a given piece of PII and then storing the PII and metadata in a “privacy protecting envelope.” The given metadata includes, without limitation, the privacy policy that applies to the PII, as well as a set of one more purpose usages for the PII that the system has collected from an end user's user agent (e.g., a web browser), preferably in an automated manner. Preferably, the PII data, the privacy policy, and the user preferences (the purpose usages) are formatted in a structured document, such as XML. The information in the XML document (as well as the document itself) is then protected against misuse during storage, access or transfer using one or more of the following techniques: encryption, digital signatures, and digital rights management. Thus, for example, in one embodiment, the XML document or portions thereof are encrypted, using W3C (World Wide Web Consortium) standard XML Encryption. This operation obscures the PII data (and, optionally, the purpose usage data) from those systems, entities or persons who do not possess (or the right to possess) an associated decryption key. The XML document or portions thereof also may be digitally signed using W3C standard XML Signatures to provide authentication, data integrity and support for non-repudiation. Further, the organization may also associate one or more “use” rights to the envelope itself using an enterprise digital rights management scheme wherein a user's rights to access the XML document are tightly managed. In addition, network access to the XML document preferably takes places as a Web service using the Simple Object Access Protocol (SOAP).

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 depicts a prior art manual approach to purpose usage selection;

FIG. 2 is a process flow illustrating an embodiment of the present invention;

FIG. 3 is a representative data processing system for use in carrying out the present invention;

FIG. 4 illustrates a technique for creating a privacy protecting envelope according to an embodiment of the present invention;

FIG. 5 illustrates the storage of the privacy protecting envelope in a database;

FIG. 6 illustrates how an access control system can be used to provide protected access to the contents of the privacy protecting envelope;

FIG. 7 illustrates how the privacy protecting envelope is used to protect the sensitive contents within the envelope during transport of the data, e.g., across an organizational boundary;

FIG. 8 is an access control system for use in protecting the PII in the envelope against unauthorized use;

FIG. 9 illustrates sample privacy policy metadata that could be contained in a privacy envelope and that describes information about a particular privacy policy;

FIG. 10 illustrates several privacy policy condition rules using XACML as the condition policy and that have been extracted from a sample privacy policy; and

FIG. 11 is an example of a request to access the data stored in a privacy envelope.

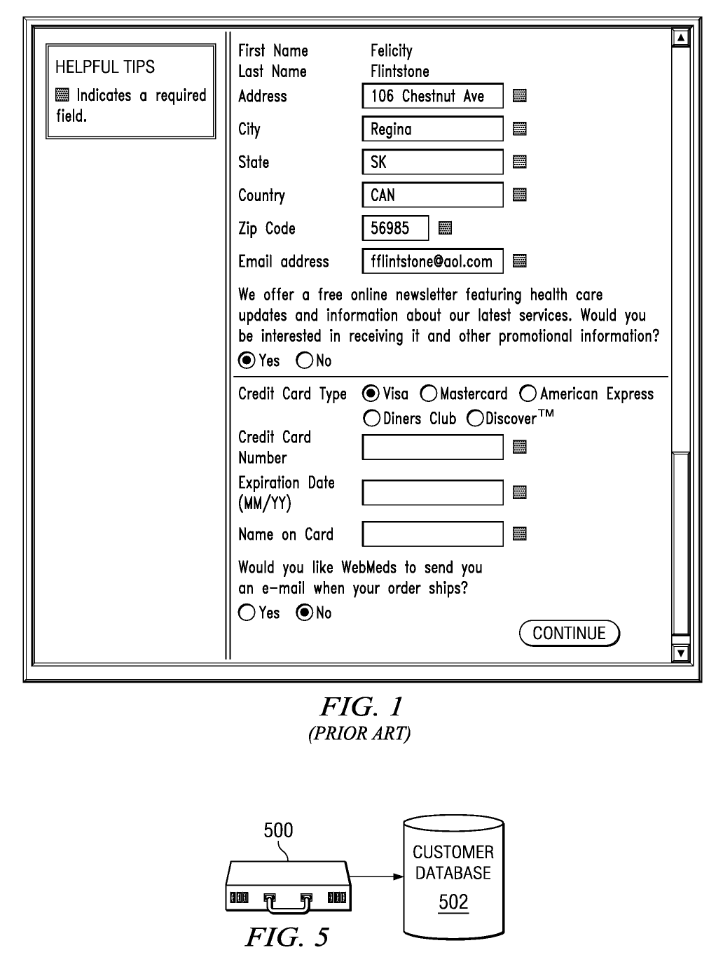

### DETAILED DESCRIPTION OF AN ILLUSTRATIVE EMBODIMENT

The present invention may operate in conjunction within the standard client-server paradigm in which client machines communicate with an Internet-accessible server (or set of servers) over an IP-based network, such as the publicly-routable Internet. The server supports a web site in the form of a set of one or more linked web pages. End users operate Internet-connectable devices (e.g., desktop computers, notebook computers, Internet-enabled mobile devices, cell phones having rendering engines, or the like) that are capable of accessing and interacting with the site. Each client or server machine is a data processing system comprising hardware and software, and these entities communicate with one another over a network, such as the Internet, an intranet, an extranet, a private network, or any other communications medium or link. As described below, a data processing system typically include one or more processors, an operating system, one or more applications, and one or more utilities. The applications on the data processing system provide native support for Web services including, without limitation, support for HTTP, SOAP, XML, WSDL, UDDI, and WSFL, among others. Information regarding SOAP, WSDL, UDDI and WSFL is available from the World Wide Web Consortium (W3C), which is responsible for developing and maintaining these standards; further information regarding HTTP and XML is available from Internet Engineering Task Force (IETF).

By way of further background, a Web service is a software system identified by a URI, whose public interface and bindings are defined and described as XML. Its definition can be discovered by other software systems. These systems may then interact with the Web service in a manner prescribed by the Web service definition, using XML-based messages conveyed by Internet protocols. As is well-known, extensible markup language (XML) facilitates the exchange of information in a tree structure. An XML document typically contains a single root element. Each element has a name, a set of attributes, and a value consisting of character data, and a set of child elements. The interpretation of the information conveyed in an element is derived by evaluating its name, attributes, value and position in the document. Simple Object Access Protocol (SOAP) is a lightweight XML based protocol commonly used for invoking Web services and exchanging structured data and type information on the Web. By way of further background, SOAP defines XML syntax and processing rules facilitating the exchange of SOAP messages. A SOAP message typically comprises a soap:Envelope that contains a soap:Body element and an optional soap:Header element. The soap:Header element may contain a set of child elements that describe some message processing desired by the sender at the recipient. Each child of the soap:Header element may contain an actor or role attribute that indicates which receiving SOAP node is expected to perform the described processing. Each child of the soap:Header may contain a soap:mustUnderstand attribute that indicates whether a SOAP node should generate a fault if a message is received containing an element that is target at that node but for which no processing is defined.

Using SOAP, XML-based messages are exchanged over a computer network, normally using HTTP (Hypertext Transfer Protocol). SOAP provides an envelope for containing a message and its processing information. SOAP itself is XML.

Typically, a Web service is described using a standard, formal XML notion, called its service description. A service description typically conforms to a machine-processable format such as the Web Services Description Language (or WSDL). WSDL describes the public interface to necessary to interact with the service, including message formats that detail the operations, transport protocols and location. The supported operations and messages are described abstractly and then bound to a concrete network protocol and message format. A client program connecting to a Web service reads the WSDL to determine what functions are available on the server. Computing entities running the Web service communicate with one another using XML-based messaging over a given transport protocol. Messages typically conform to the Simple Object Access Protocol (SOAP) and travel over HTTP (over the public Internet) or other reliable transport mechanisms (such as IBM® MQSeries® technologies and CORBA, for transport over an enterprise intranet). The Web service hides the implementation details of the service, allowing it to be used independently of the hardware or software platform on which it is implemented and also independently of the programming language in which it is written. This allows and encourages Web services-based application to be loosely-coupled, component-oriented, cross-technology implementations. Web services typically fulfill a specific task or a set of tasks. They can be used alone or with other Web services to carry out a complex aggregation or a business transaction. A client program connecting to a Web service reads the WSDL to determine what functions are available on the server.

The Organization for the Advancement of Structured Information Standards (OASIS) has recently ratified various Web Services Security (WSS) standards to provide an extensible framework for providing message integrity, confidentiality, identity propagation, and authentication. WS-Security is a standard that describes how to secure a Web Service. It includes the XML Signatures, as well as the XML Encryption. XML Signatures describes how to digitally sign an XML document or a portion of the XML document tree. XML Encryption describes how to encrypt an XML document or a portion of the XML document tree. Thus, using XML Encryption obscures given XML-formatted data, while using XML Signature adds authentication, data integrity, and support for non-repudiation to the PII data that is signed. A feature of both XML Encryption and XML Signatures is the ability to encrypt or sign (as the case may be) only specific portions of the XML tree rather than the complete document.

More specifically, XML Signatures is a proposed W3C Recommendation that describes XML syntax and processing rules for creating and representing digital signatures. XML Signatures are designed to facilitate integrity protection and origin authentication for data of any type, whether located within the XML that includes the signature or elsewhere. An important property of XML Signature is that signed XML elements along with the associated signature may be copied from one document into another while retaining the ability to verify the signature. This property can be useful in scenarios where multiple actors process and potentially transform a document throughout a business process. XML Encryption is another proposed W3C Recommendation that provides end-to-end security for applications that require secure exchange of structured data. XML itself is the most popular technology for structuring data, and therefore XML-based encryption is the natural way to handle complex requirements for security in data interchange applications. With XML Encryption, each party can maintain secure or insecure states with any of the communicating parties. Both secure and non-secure data can be exchanged in the same document.

Techniques for generating an XML Signature are described in the W3C Recommendation, which is incorporated herein by reference. In particular, XML Signatures use a set of indirect references to each signed data object, allowing for the signing of several potentially noncontiguous and/or overlapping data objects. For each signed data object, a ds:Reference element, which points to the object via a Uniform Resource Identifier (URI), contains a digest value computed over that object. The digest value is computed using a given function such as MD5, SHA-1, a CRC, a combination thereof, or the like. The complete set of references is grouped together under a ds:SignedInfo element. The value of the ds:SignatureValue is then computed over the ds:SignedInfo element.

Likewise, techniques for generating an XML Encryption are described in the associated W3C Recommendation, which are also incorporated herein by reference.

With the above as background, further details of the present invention can now be provided, as set for the below. As noted above, preferably a user's PII is associated with a privacy policy and a set of one more purpose usage selections. The privacy policy typically is exposed at the site, and this policy may be updated or modified frequently. A purpose usage selection typically is provided by the end user that has been requested to provide the site with given PII data. Preferably, the end user's purpose usage selections are obtained in an automated manner, as is now described.

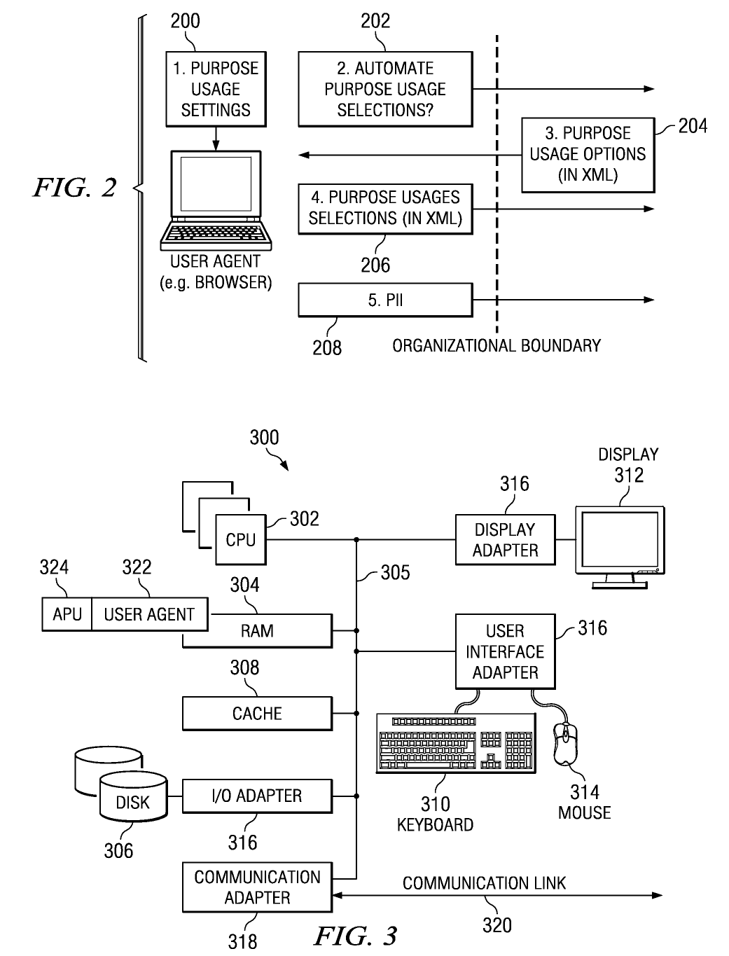

In particular, FIG. 2 shows a set of steps in the automation of privacy purpose usage selections. First, at step 200, the end user configures his or her user agent (typically, a web browser) with desired purpose usage settings. In the usual case, this configuration step, which is described in more detail below, takes place off-line, i.e., without the user agent opened to a given web site (or page). At step 202, the user navigates to a web site that has been enabled for automated purpose usage. At step 204, the web site automatically provides the user agent a list of one or more purpose usage option(s) that need to be responded to by the user. Typically, the option(s) are provided by an XML information exchange, although this is not a requirement. At step 206, the user—via the user agent—provides the response(s) to the purpose usage option(s). Step 206 typically is automated, partially automated, or interactive, in accordance with how the end user has configured his or her user agent. With the purpose usages selected in this automated manner, the user can then safely provide his or her personally identifying information (PII).

Each of these steps will be further described in detail below.

The first step (step 200 in FIG. 2) configures the purpose usage settings in the user agent. In particular, preferably the user agent is first configured to determine how it should implement automated purpose usage selections. In one embodiment, the user agent is configured either to support automated purpose usages, or to not support this function. In another embodiment, a set of selections preferably are managed according to one of several alternative modes: a fully automatic mode (in which case the user agent answers to each purpose usage query from all web sites), a semi-automatic mode (in which case the user agent answers to each purpose usage query from only “trusted” web sites, as defined below), or an interactive mode (in which case the user agent only provides answers to each purpose usage query after prompting the user and getting a permission). If the semi-automatic mode is in effect and the given web site (or Web service) to which the end user has navigated is not on a list of trusted sites, preferably the user agent falls back to the interactive mode. In yet another embodiment, a set of selections are managed according to one of several setting types: standard settings (in which case the user agent makes selections using a standard list of purpose usages, which selections are then used for all web sites), semi-standard settings (in which case the user agent makes selections using a standard list of purpose usages that are used only for “trusted” web sites), and individual settings (in which case the user agent prompts the user for purpose usages for the particular web site being visited). As before, if the semi-standard settings type is in effect and the given web site to which the end user has navigated is not on a list of trusted sites, preferably the user agent falls back to the individual settings mode. The standard list of purpose usages may include an industry specific standard list, a custom standard list created by an individual web site, a list provided by a standards organization, or the like.

The various configurations described above are merely exemplary. One or more of these configurations may be combined.

The second step (step 202 in FIG. 2) detects if the web site (or, more generally, the Web service) is enabled for automated purpose usage. This step typically occurs when an end user opens his or her user agent to a web site. Although not required, a web site may advertise to the end user (e.g., by way of a given icon on the site) that it is enabled for automated purpose usage selection according to the present invention. Preferably, however, step 202 takes place via an automated information exchange between the user agent and the site itself. To this end, an XML or other file (indicating that the site supports automated purpose usage settings) is defined and stored in a standard place on the web site. This is similar to P3P where a given directory is identified to hold the P3P files. For example, the purpose usage setting file is stored in a known directory, such as /auto-purpose/. The user agent determines if the web site supports automated purpose usage via a simple message exchange. In particular, this determination can be enabled by an XML-based information exchange between the user agent and the site, with the user agent going to the directory to perform a simple check on the support of automated purpose usage. The XML file preferably contains a set of one or more configuration options, namely, the list of required or desired purpose usage settings. The XML file may conform to XACML, the Extensible Access Control Markup Language standard. [NOTE TO PAUL—please provide me a sample of one such XML file so we can include it in the description and figures].

In the third step (step 204 of FIG. 2), the web site (or Web service) provides the user agent a list of one or more purpose usage options. Once again, this is a simple XML-based information exchange. If desired, there may be a separate purpose usage option list (in the form of an XML code snippet) for each different PII entry form on the web site. In the latter case, the PII entry form may contain a cookie or hidden field to inform the user agent of the place to find the purpose usage option list file.

In the fourth step (step 206 of FIG. 2), the user agent provides the purpose usage selections. Depending on the configuration settings as described above (in step 200), the user agent provides the list of purpose usage selections either completely without further user input, or this step may require varying levels of user input. As has been described, the amount of manual intervention depends on the user's configuration settings and, in some cases, if the web site is considered by the user agent to be trusted. The purpose usage selections are provided to the web site using various any convenient method. Thus, for example, at a minimum, a simple HTTP POST protocol may be used to send the selections to the web site (or Web service). In the alternative, more sophisticated client-side techniques may be used to facilitate this information exchange. Thus, for example, although not required, the user agent may implement AJAX (Asynchronous Javascript and XML), which are a known set of web development techniques that enhance web page interactivity, speed and usability. AJAX technologies include XHTML (Extensible HTML) and CSS (Cascading Style Sheets) for marking up and styling information, the use of DOM (Document Object Model) accessed with client-side scripting languages, the use of an XMLHttpRequest object (an API used by a scripting language) to transfer XML and other text data asynchronously to and from a server using HTTP), and use of XML or JSON (Javascript Object Notation, a lightweight data interchange format) as a format to transfer data between the server and the client. Any of these technologies may be used for sending the purpose usage selections to the web site (or Web service) that has been enabled for automated purpose usage selection exchange.

At the fifth step (step 208 of FIG. 2), the organization receives the PII. In particular, once the user agent has provided the purpose usage selections to the web site (or Web service), the organization receives the PII. As will be seen, preferably PII data is provided to the web site (or to the Web service) in a privacy-protected manner, such as via XML encryption and XML digital signature technologies. This aspect of the present invention will be described in more detail below. In this manner, the user has shown explicit consent to the purpose usages, and the organization can use this as evidence of the user's wishes.

FIG. 3 illustrates a representative data processing system 300 for use as the client machine. A data processing system 300 suitable for storing and/or executing program code will include at least one processor 302 coupled directly or indirectly to memory elements through a system bus 305. The memory elements can include local memory 304 employed during actual execution of the program code, bulk storage 306, and cache memories 308 that provide temporary storage of at least some program code to reduce the number of times code must be retrieved from bulk storage during execution. Input/output or I/O devices (including but not limited to keyboards 310, displays 312, pointing devices 314, etc.) can be coupled to the system either directly or through intervening I/O controllers 316. Network adapters 318 may also be coupled to the system to enable the data processing system to become coupled to other data processing systems or devices through intervening private or public networks 320. The data processing system 300 also includes the user agent 322. The automated purpose usage support is provided by code 324, which may be native to the user agent, an applet or other plug-in, a script, an AJAX snippet, or the like. This code also may be served to an end user's client machine when the end user accesses an enabled web site, although in the usual case it is persistent on the client machine.

In a simple embodiment, an end user accesses an enabled web site in by opening the user agent to a URL associated with a service provider domain. The user authenticates to the site (or some portion thereof) by entry of a username and password. The connection between the end user entity machine and the system may be private (e.g., via SSL). Although connectivity via the publicly-routed Internet is typical, the end user may connect to the system in any manner over any local area, wide area, wireless, wired, private or other dedicated network. A representative web server is Apache (2.0 or higher) that executes on a commodity machine (e.g., an Intel-based processor running Linux 2.4.x or higher). A data processing system such as shown in FIG. 3 also can be used as to support the server architecture.

In a preferred embodiment, the submission of the PII data and the automated purpose usage collection mechanism described above is exposed to the user agent as a Web service. As noted above, the Web service is described using a WSDL-compliant service description. As noted above, preferably the client program (the user agent) connecting to a Web service reads the WSDL to determine what functions are available on the organization's server. Computing entities running the Web service communicate with one another using XML-based messaging over a given transport protocol. Messages typically conform to the Simple Object Access Protocol (SOAP) and travel over HTTP (over the public Internet) or other reliable transport mechanisms (such as IBM® MQSeries® technologies and CORBA, for transport over an enterprise intranet). It should also be appreciated that SOAP messages need not be provided to the Web service directly; in the more general case, SOAP messages are sent from the initial SOAP sender to an ultimate SOAP receiver along a SOAP message path comprising zero or more SOAP intermediaries that process and potentially transform the SOAP message.

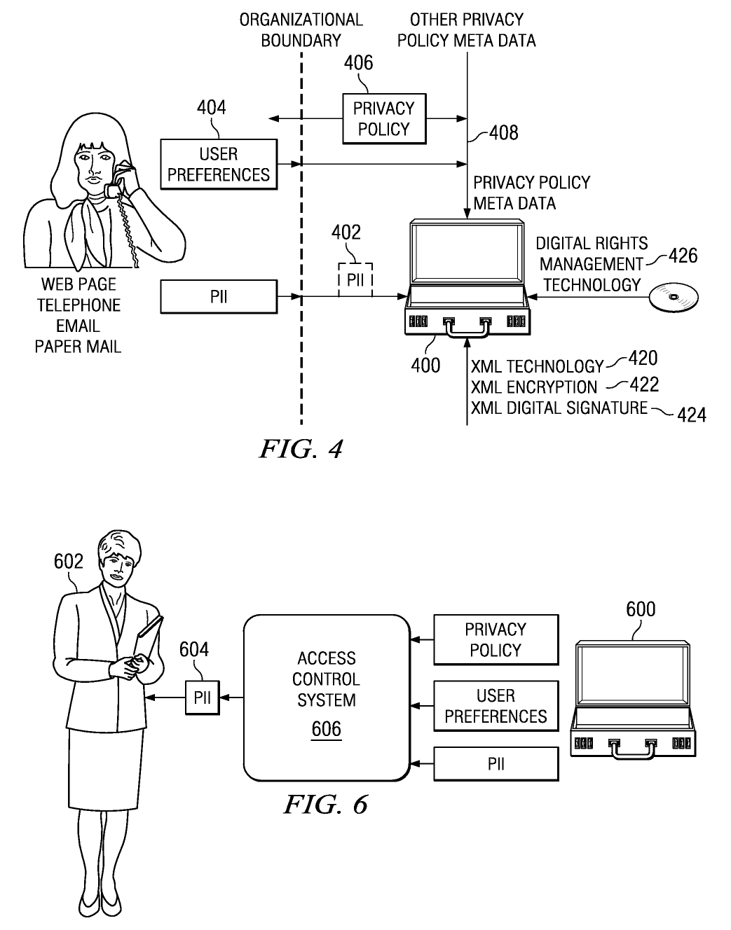

According to a feature of the present invention, a user's PII is protected during storage, access or transfer of the data to the organization and the Web service. Preferably, this objective is accomplished by associating given “metadata” with a given piece of PII that has been submitted and then storing the PII and metadata in a “privacy protecting envelope” such as now described with respect to FIG. 4. As used herein, the “privacy protecting envelope” 400 is a structure (or, more generally, an information construct) that maintains the PI data itself 402, the user preferences 404 (e.g., the purpose usages, and possibly one or more other user preferences, such as how long before the user expects the organization to delete the information entirely), the associated privacy policy 406, and one or more other sets of policy metadata (such as organization-specific information, namely, an explanation of PII types, a PII taxonomy, or the like) 408. Preferably, the envelope 400 comprises the PII, the privacy policy, and at least one purpose usage that has been obtained via the automated mechanism described above with respect to FIG. 2. The envelope may comprise one piece of PII data, or many pieces. As can be seen, by using the envelope metaphor, any arbitrary piece of PII data can be seen to be associated with any given privacy policy, and any given purpose usage. In this way, the creation of a privacy protecting envelope can be seen to occur on the (PII) piece-by-piece basis.

The envelope is created by applying one of more technologies, namely information exchange via a structured document 420, encryption 422, digital signing 424, and digital rights management 426. Thus, in a representative system, the information exchange uses XML, the encryption is implemented via XML Encryption, the digital signing is implemented via XML Signatures, and the rights management (DRM) is implemented via a DRM system. Preferably, the envelope is created as or in conjunction with a Web service, using given message transport (e.g., SOAP) between the user agent and the organization's site.

It is not required that all four (4) of the above technologies be used to create the PII envelope. In one embodiment, the envelope is created applying XML Encryption to portions of a XML document tree that comprise the PII, the privacy policy and the purpose usage for the PII. In particular, XML Encryption is applied to the PII, or the PII and the purpose usage, while the privacy policy is included in the document tree in an unencrypted manner.

In another embodiment, the above-identified partially-encrypted XML document tree (comprising the PII data, the privacy policy and the purpose usage) is also digitally signed (in whole or in part) by XML Signatures to create the envelope. By applying XML Signatures, all or some of the envelope's contents (e.g., the PII, or the PII and purpose usage, as such portions are encrypted by XML Encryption) are also digitally signed. As noted above, the XML Signature provides authentication, data integrity and support for non-repudiation of the information that is associated with the digital signature.

In yet another alternative embodiment, the envelope may be created by simply applying a XML Signature to all or some of the envelope's contents (namely, the PII, or the PII and purpose usage, or the purpose usage itself, or the like) without using encryption. In such case, the envelope is formed using just the XML Signature.

In still another embodiment, the envelope is created by encryption and digital signing, as already described, together with digital rights management. In particular, the organization may also associate one or more “use” rights to the envelope itself using an enterprise digital rights management scheme wherein a user's rights to access the XML document are tightly managed. In a representative enterprise DRM system, a policy server (e.g., dedicated hardware running purpose designed software) provides the desired functionality. As is well-known in such systems, the policy server is used to manage how the XML document (and thus the PII therein) is accessed, viewed, distributed or otherwise exploited. Thus, for example, the DRM technology ensures that the PII is accessible only under certain conditions, such as limiting the viewing of such data to particular locations, particular devices, given circumstances, to given authorized users, or any combination thereof. An end-to-end DRM system typically comprises several components: encryption, business-logic and license (rights)-delivery. The policy server enables a system administrator or other content owners to change and securely enforce user permissions (view, copy, forward, print or edit) and recall documents after they have been distributed. To access a protected document (which may be of any type) in such a system, the policy server typically provides a calling application plug-in with a decryption key and a policy that are then applied at the application to enable access to and use of the protected document.

In a further embodiment, the privacy protecting envelope is created by applying DRM without any associated XML encryption and/or XML Signature.

Another concrete example of the envelope is a SOAP message protected with WS-Security, which allows selective encryption and signing of the SOAP body information. In particular, the body would contain the privacy policy, the user preferences, and the PII data, as has been described. The envelope creator would then decide which parts are encrypted and signed.

As can be seen then, the present invention provides the Web site (or, more generally the Web server or the enterprise) with varying amounts of coarse- or fine-grain protection for a given piece of PII and, in particular, to a given piece of PII and its associated purpose usage that has been received by the site using the automated techniques described in FIG. 2. Indeed, the particular “envelope” created for a particular piece of PII and its associated purpose usage may be quite varied. A first envelope may comprise a first piece of PII, a first purpose usage, and a first privacy policy; a second envelope may comprise a second piece of PII, a second purpose usage, and the first privacy policy, or a second privacy policy. The first envelope may be created using XML and XML Encryption, or XML, XML Encryption and XML Signatures, while the second envelope may be created using XML, XML Encryption, XML Signatures and DRM. Yet a third envelope may comprise third and fourth PII pieces, third and fourth purpose usages, and yet another privacy policy; once again, the third envelope is created by applying one or more of the above-described envelope-generating technologies.

In this manner, the personally identifying (or other sensitive) information in the XML document (as well as the document itself) is protected against misuse during storage, access or transfer. FIGS. 5-7 illustrate how the end user's PII is protected throughout its life cycle by using the privacy protecting envelope. In FIG. 5, the privacy protecting envelope 500 (which is now shown as closed or sealed) is stored in the organization's storage system 502. The storage system 502 may be a relational database (RDMBS) or similar repository, or it may be an XML-enabled database, such as IBM DB2 XML Extender. One or more subsets of data are extracted from the envelope stored in the storage system 502 in a conventional manner, such as by using an XML query language such as XPath or XQuery. As is well-known, XPath is a language for addressing parts of an XML document that utilizes a syntax that resembles hierarchical paths used to address parts of a file system or URL. XQuery is a query language that operates in the manner as Structured Query Language (SQL) does for relational databases.

FIG. 6 illustrates an envelope 600 and how the PII therein 604 may be accessed by a permitted user 602 via an access control system 606. The access control system 606 may be implemented in any convenient manner. In particular, a representative access control system is implemented in a Web services environment that includes an access manager, which is a component that prevents unauthorized use of resources, including the prevention of use of a given resource in an unauthorized manner. A representative access manager is the Tivoli® Access Manager product, which is available commercially from IBM, and is represented in FIG. 8. Of course, the identification of this commercial product is not meant to be taken as limiting. Other commercial products and systems include Tivoli Privacy Manager, Computer Associates SiteMinder, and the like. More broadly, any system, device, program or process that provides a policy/access/service decision may be used for this purpose. Preferably, the access manager provides access control capabilities that conform to The Open Group's authorization (azn) API standard. This technical standard defines a generic application programming interface for access control in systems whose access control facilities conform to the architectural framework described in International Standard ISO 10181-3. The framework defines four roles for components participating in an access request: (1) an initiator 800 that submits an access request (where a request specifies an operation to be performed); (2) a target 802 such as an information resource or a system resource; (3) an access control enforcement function (AEF) 804; and (4) an access control decision function (ADF) 806. As illustrated, an AEF submits decision requests to an ADF. A decision request asks whether a particular access request should be granted or denied. ADFs decide whether access requests should be granted or denied based on a security policy, such as a policy stored in database 308. Components 804, 806 and 808 comprise the access manager. Security policy typically is defined using a combination of access control lists (ACLs), protected object policies (POPs), authorization rules, and extended attributes. An access control list specifies the predefined actions that a set of users and groups can perform on an object. For example, a specific set of groups or users can be granted read access to the object. A protected object policy specifies access conditions associated with an object that affects all users and groups. For example, a time-of-day restriction can be placed on the object that excludes all users and groups from accessing the object during the specified time. An authorization rule specifies a complex condition that is evaluated to determine whether access will be permitted. The data used to make this decision can be based on the context of the request, the current environment, or other external factors. For example, a request to modify an object more than five times in an 8-hour period could be denied. A security policy is implemented by strategically applying ACLs, POPs, and authorization rules to those resources requiring protection. An extended attribute is an additional value placed on an object, ACL or POP that can be read and interpreted by third party applications (such as an external authorization service). The access manager authorization service makes decisions to permit or deny access to resources based on the credentials of the user making the request and the specific permissions and conditions set in the ACLs, POPs, authorization rules and extended attributes.

If an external access control system is being used to provide access to the PII, then (as indicated in FIG. 6) then preferably envelope is opened and the privacy policy and user preferences (and other metadata, if appropriate) are examined before the requestor is afforded access to the PII. This functionality is carried out using the access control system as previously illustrated.

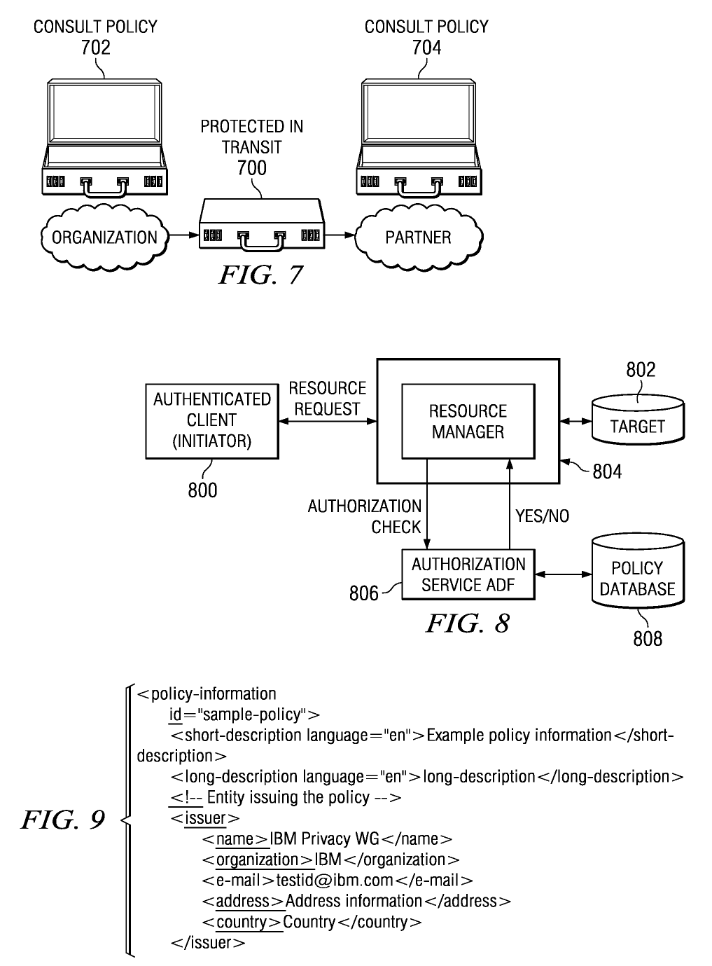

Moreover, one of ordinary skill in the art will also appreciate that the privacy protecting envelope also protects against the wrongful use or disclosure (inadvertent or intentional) of the PII during transfer of the information within the organization or between an organization and a partner entity, as illustrated in FIG. 7. In this example, the envelope 700 is being transferred from the organization 702 that received the PII (and purpose usage data) to a partner entity 704. Once again, the envelope is shown as been closed to protect the PII. The information is also protected at the partner site because the envelope preferably carries the privacy policy and the user preferences. This policy and preference may then be enforced by the partner's local access control system. In a representative embodiment, SOAP messages are sent from organization (or, more generally, a SOAP sender) 700 to the partner entity (or, more generally, a SOAP receiver along a SOAP message path comprising zero or more SOAP intermediaries that process and potentially transform the SOAP message.

The present invention provides numerous advantages. The envelope contains privacy policy meta information so that any authorized person or entity receiving the envelope can determine how the PII should be treated. This metadata, as described above, may identify the privacy policy in place when the PII was received, the user preferences for the different purpose usage of the data, the meaning of PII information, or the like. In one embodiment, the envelope is created using digital rights management technology so that the envelope itself can carry (or be associated with one or more controls) over the data access. For example, a DRM overlay may limit access to the envelope except at a certain locations, or by a certain device, or by a certain user, or for a limited number of accesses, or any combination thereof. During storage and/or transfer, the PII data preferably is protected from casual exposure using encryption, such as XML Encryption. The authenticity and integrity of the privacy protecting envelope and its contents are ensured using digital signature technology, such as XML Signatures.

Because the privacy metadata preferably is stored with each PII submitted, the metadata may be different for each PII received. This is appropriate in a privacy scenario, because the privacy policy (for instance) may change at any time, and it is desirable to treat data under the privacy policy in which it was submitted.

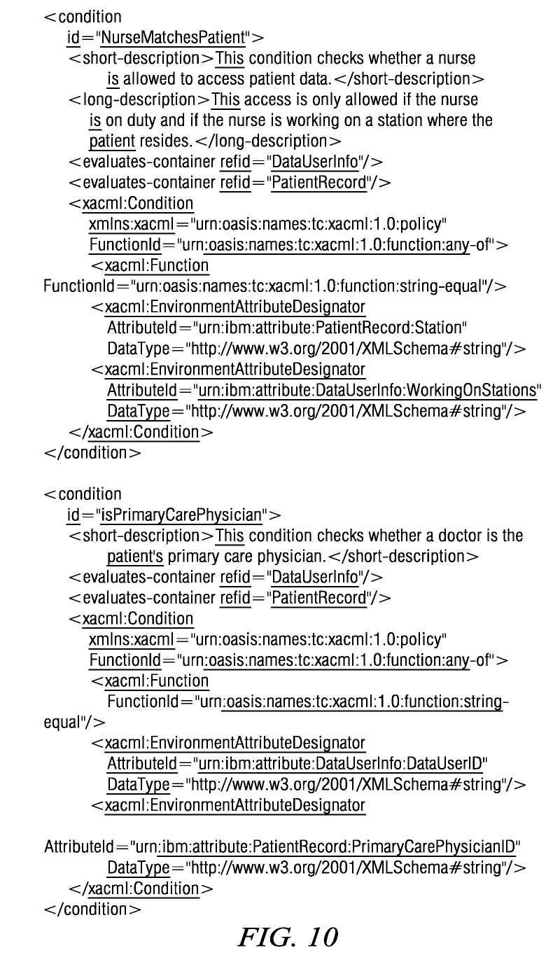

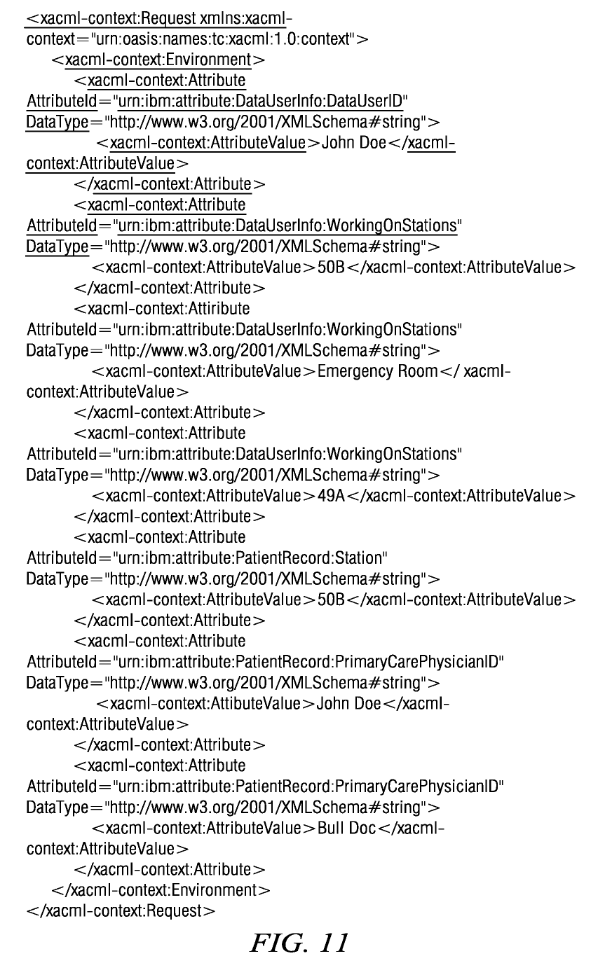

FIG. 9 illustrates sample privacy policy metadata that could be contained in a privacy envelope and that describes information about a particular privacy policy. The privacy policy itself typically is a set of rules with attributes, such as ALLOW user-category action on data-category for purpose with conditions [with optional obligations]. An example rule in the context of medical PII then might be: ALLOW doctors to read medical_records for treatment if [doctor is primary care physician] [obligation: audit access to information]. Continuing with this example, FIG. 10 illustrates several privacy policy condition rules using XACML as the condition policy; they are an extract from the privacy policy. In this case, the rules describe some permitted access to provided medical PII. FIG. 11 is an example of a request to access the data stored in the privacy envelope. As previously described, the privacy authorization system would look at this request, evaluate the policy and user preferences, and then decide if access is allowed.

More generally, the invention can take the form of an entirely hardware embodiment, an entirely software embodiment or an embodiment containing both hardware and software elements. In a preferred embodiment, the invention (comprising the client side functionality, the server side functionality, or both) is implemented in software, which includes but is not limited to firmware, resident software, microcode, and the like. Furthermore, as noted above, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

One or more of the above-described functions may also be implemented as a service in a hosted manner. Thus, for example, a user's automated purpose usage configuration and selections may be hosted on an information service and provided on demand to the automated purpose usage-enabled web site. In addition, the present invention may be implemented within the context of a federated environment, such as described in U.S. Publication No. 2006/0021018, filed Jul. 21, 2004. As described in that document, a federation is a set of distinct entities, such as enterprises, organizations, institutions, etc., that cooperate to provide a single-sign-on, ease-of-use experience to a user. Within a federated environment, entities provide services that deal with authenticating users, accepting authentication assertions (e.g., authentication tokens) that are presented by other entities, and providing translation of the identity of a vouched-for user into one that is understood within a local entity. The automated purpose usage configuration and selections and envelope creation functions as described herein may be an additional service provided by a given entity in a federated environment.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

Finally, while given components of the system have been described separately, one of ordinary skill will appreciate that some of the functions may be combined or shared in given instructions, program sequences, code portions, and the like.

Having described our invention, what we now claim is as follows:

1. A method, implemented as a Web service, comprising:
responsive to a query from a user agent that has been pre-configured with a set of one or more purpose usage selections, providing to the user agent a purpose usage option;
receiving from the user agent at least one purpose usage setting from the set of one or more purpose usage selections that have been pre-configured;
receiving personally identifying information (PII); and
applying a given function to the PII, the at least one purpose usage setting and a privacy policy to generate a secure information envelope.

2. The method as described in claim 1 wherein the secure information envelope is XML-compliant

3. The method as described in claim 2 wherein the given function encrypts at least the PII to generate the secure information envelope

4. The method as described in claim 2 wherein the given function digitally signs at least the PII to generate the secure information envelope.

5. The method as described in claim 2 wherein the given function applies an encryption to at least the PII and then digitally signs a resulting encrypted PII to generate the secure information envelope.

6. The method as described in claim 1 further including applying an access control to the secure information envelope.

7. The method as described in claim 1 wherein the given function applies a rights management policy to the PII to generate the secure information envelope.

8. The method as described in claim 1 wherein the given function is one of: encryption, digital signing, and digital rights management, and a combination thereof.

9. The method as described in claim 1 wherein the Web service is identified via WSDL and is accessible via SOAP.

10. A computer-readable medium having computer-executable instructions for performing the method steps of claim 1.

11. A server comprising a processor, and a computer-readable medium, the computer-readable medium having processor-executable instructions for performing the method steps of claim 1.

12. A computer program product comprising a computer useable medium having a computer readable program, wherein the computer readable program when executed on a server causes the server to perform the following method steps:
displaying, as a Web service or web site, at least one page that has been enabled for automated purpose usage selection, comprising:
responsive to a message query from a user agent that has been pre-configured with a set of one or more purpose usage selections, providing to the user agent a purpose usage option;
receiving from the user agent at least one purpose usage setting from the set of one or more purpose usage selections that have been pre-configured;
receiving personally identifying information (PII); and
applying a given function to the PII, and at least one purpose usage setting to generate a secure information envelope.

13. The computer program product as described in claim 12 wherein the given function is one of: encryption, digital signing, and digital rights management, and a combination thereof.

14. The computer program product as described in claim 12 wherein the given function is also applied to a privacy policy.

15. The computer program product as described in claim 14 wherein a first given function is applied to a first piece of PII and a first purpose usage setting, and a second given function is applied to a second piece of PII and a second purpose usage setting.

16. A method, managed as a Web service having a privacy policy associated therewith, of managing sensitive information, comprising:
receiving from the user agent personally identifying information (PII) together with a user preference;
applying a given function to the PII, the user preference and the privacy policy to generate a privacy protecting envelope, the given function being one of: encryption, digital signing, and digital rights management, and a combination thereof;
taking a given action with respect to the privacy protecting envelope in lieu of the PII.

17. The method as described in claim 16 wherein the given action stores the privacy protecting envelope.

18. The method as described in claim 16 wherein the given action enables access to the PII to an authorized entity.

19. The method as described in claim 16 wherein the given action enables use of the PII according to a management policy.

20. The method as described in claim 16 wherein the given action transmits the privacy protecting envelope from a first location to a second location in a manner that prevents disclosure of the PII in the privacy protecting envelope.
